(19) United States
(12) Patent Application Publication
(10) Pub. No.: US 2020/0262158 A1
(43) Pub. Date: Aug. 20, 2020

(54) DEVICE AND METHOD FOR PRODUCING A SEMI-FINISHED PRODUCT WEB

(71) Applicant: Covestro Deutschland AG, Leverkusen (DE)

(72) Inventors: Matthias Knaupp, Langenfeld (DE); Thomas Grimm, Köln (DE); Henning Börger, Markt Erlbach (DE)

(21) Appl. No.: 15/781,620

(22) PCT Filed: Dec. 14, 2016
(86) PCT No.: PCT/EP2016/080864

§ 371 Date: Jun. 5, 2018

(30) Foreign Application Priority Data
Dec. 17, 2015 (EP) 15200643.3

(51) Int. Cl. B29C 70/20; B29C 70/54

(52) U.S. Cl. CPC B29C 70/20; B29K 2069/00; B29C 70/545

(57) ABSTRACT

The present invention relates to an apparatus and a process for semicontinuous production of a semifinished sheeting constructed from unidirectionally endless-fibre-reinforced sheeting sections and also to a process for producing this semifinished sheeting, wherein the fibres in the final semifinished sheeting are aligned at an angle x having a magnitude from non-0° to 90° inclusive to the longest axis of the final semifinished sheeting.

The present invention relates to an apparatus and a process for semicontinuous production of a semifinished sheeting constructed from unidirectionally endless-fibre-reinforced sheeting sections and also to a process for producing this semifinished sheeting, wherein the fibres are embedded in a matrix of polycarbonate and in the final semifinished sheeting are aligned at an angle x having a magnitude from non-0° to 90° inclusive to the longest axis of the final semifinished sheeting.

This final semifinished sheeting is also referred to hereinbelow as “x°-tape”.

Tapes where the fibres in the semifinished sheeting are aligned at an angle x of 0° to the longest axis of the semifinished sheeting are referred to hereinbelow as “0°-tape” for short. One use of these 0°-tapes is as a precursor for the production of x°-tapes.

The term “tape” is used to mean both 0°-tapes and x°-tapes. The long sides of the tapes run parallel to one another.

In the context of the present invention semicontinuous production is to be understood as meaning a production process which comprises both process steps which proceed or are performed continuously and process steps which proceed or are performed discontinuously.

The x°-tape produced according to the invention on the apparatus according to the invention inter alia has the characteristic that the fibres are not disposed in a direction of 0° to the longest axis of the tape as in the case of 0°-tapes but rather are aligned at an angle x to the advancement direction, wherein the angle x is non-0°. The longest axis of a tape is also referred to as the running direction. “Endless-fibre-reinforced” is to be understood as meaning that the length of the reinforcing fibre is substantially equal to the dimension of the tape to be reinforced in the direction of the fibres. “Unidirectionally” in connection with “fibre” is to be understood as meaning that the fibres in the tape are aligned in only one direction.

The use of fibre-reinforced materials has steadily increased in the last decades on account of their outstanding specific properties. Fibre-reinforced materials are employed in structures subject to acceleration in particular, in order to allow weight reduction and thus minimize energy consumption without incurring a loss of strength or stiffness of the material.

A fibre-reinforced material, also known as fibre composite or composite for short, is an at least biphasic material consisting of a matrix material in which fibres are substantially completely embedded and encased. The matrix has a shape-conferring function, is intended to protect the fibres from external influences and is necessary to transfer forces between the fibres and to introduce external loads. The fibres make a decisive contribution to the mechanical performance of the material, with glass, carbon, polymer, basalt or natural fibres often being employed in industry. Depending on the intended use, matrix materials employed are generally thermosetting or thermoplastic polymers, occasionally even elastomers.

Thermosetting polymers are already long established in a great many industries. However, a decisive disadvantage is the lengthy curing time which leads to correspondingly lengthy cycle times during processing to afford components. This makes thermoset-based composites unattractive especially for high-volume industry applications. By contrast, thermoplastic-based composites, provided they are in the form of fully-consolidated semifinished products, e.g. as endless-fibre-reinforced sheets or profiles, are often merely heated, formed and cooled when subjected to further processing, which may nowadays be achieved in cycle times of well under one minute. The processing may also be combined with further process steps, for example insert-molding with thermoplastics, which makes it possible to achieve a very high degree of automation and integration of functions.

Reinforcing materials used are essentially semifinished textile products such as wovens, multi-ply laids or nonwovens (e.g. batts, random-laid fibre mats etc). It is a characteristic of these forms of fibre reinforcement that the orientation of the fibre—and thus the force paths in the subsequent component—is already determined in the semifinished textile product. While this does allow direct production of a multidirectionally reinforced composite it has disadvantages in terms of flexibility of ply construction, mechanical properties and economy. In thermoplastic-based systems these semifinished textile products are typically impregnated with polymer under the action of pressure and temperature and then cut to size and subjected to further processing as a cured sheet.

In addition to these already established systems based on semifinished textile products, thermoplastic-based tapes are becoming increasingly important. These offer economy advantages since the process step of semifinished textile product production may be eschewed. These thermoplastic-based tapes are suitable for producing multi-ply constructions, particularly also for producing multidirectional constructions.

A process and an apparatus for producing a thermoplastic-based semifinished sheeting reinforced with unidirectionally aligned endless fibres are described in WO 2012 123 302 A1, the disclosure of which is hereby fully incorporated into the description of the present invention by reference. The disclosed process/the disclosed apparatus affords a fibre-reinforced semifinished sheeting where the endless fibres are aligned in a direction of 0° to the running direction of the supply sheeting.

A process and an apparatus for producing a unidirectionally endless-fibre-reinforced tape are also described in EP 2 631 049 A1, the disclosure of which is likewise hereby fully incorporated into the description of the present invention by reference.

In the process disclosed in EP 2 631 049 A1, to produce an x°-tape, segments are separated from a supply sheeting having a main direction, a plastic matrix and a multiplicity of fibres fixed in a unidirectionally oriented manner and enclosing an angle of 0° to the running direction, these segments are arranged next to one another so that their longitudinal edges extending parallel to the running direction are parallel to one another and adjacent and enclose the predetermined angle to the longitudinal direction, and adjacent segments are then joined to one another in the region of their longitudinal edges. The supply sheeting thus corresponds to a 0°-tape and a segment corresponds to a sheeting section. In the x°-tape the fibres are then arranged at an angle x non-0° to the running direction of the x°-tape.

The apparatus disclosed in EP 2 631 049 A1 comprises a dispensing arrangement for dispensing segments of the supply sheeting having a main direction, a plastic matrix and a multiplicity of fibres fixed in a unidirectionally oriented manner and enclosing an angle of 0° to the main direction, an aligning device for arranging the segments next to one another so that their longitudinal edges extending parallel to the main direction are parallel to one another and adjacent and enclose a predetermined angle (a) to the longitudinal direction, and a joining device for joining the adjacent segments in the region of their longitudinal edges.

The disadvantage of the apparatus disclosed in EP 2 631 049 A1 is that—viewed from above—the dispensing arrangement and the aligning arrangement must be arranged at an angle to one another of 180° minus the predetermined angle (a) in order to achieve a joining of the segments such that in the x°-tape the fibres have an alignment of non-0° to the longest running direction of the x°-tape. This means in other words that the apparatus does not form a continuous straight line but rather the dispensing arrangement of the material is arranged at an angle (a) to the aligning arrangement, i.e. figuratively speaking the apparatus has a bend in its arrangement.

This in turn has the disadvantage that such an apparatus requires substantially more space in a machine hall for example. This applies in particular when a plurality of apparatuses of this type are to be accommodated in a machine hall.

It is an additional disadvantage of this type of apparatus that setting different angles (a) of the fibres to the running direction also requires that the angle between the dispensing arrangement and the aligning arrangement be changed accordingly. This is inconvenient and increases constructional complexity and also renders the system more susceptible to faults and further increases the aforementioned space disadvantage.

The disadvantage of the process is that the advancement direction of the segments changes. This makes the process more susceptible to faults, inter alia during joining of the adjacent segments in the region of their longitudinal edges, and can result in discontinuities and delays in the production of the x°-tape.

In addition, the apparatus disclosed in EP 2 631 049 A1 is not used to produce tapes comprising the thermoplastic polycarbonate as the matrix material. One of the reasons therefor is the aforementioned susceptibility to faults of the process for producing tapes with the apparatus disclosed in EP 2 631 049 A1, in particular during joining of the adjacent segments in the region of their longitudinal edges.

Compared to the typically employed thermoplastic plastics, polycarbonates have the disadvantage that they have little propensity for creep and thus have a tendency for cracking when under constant stress. This is highly problematic particularly for use in composites comprising endless fibres because composites comprising endless fibres in their plastic matrix are under constant stress due to the endless fibres. Until now, polycarbonates have therefore in practice played only a subordinate role as a plastic matrix for such composites comprising endless fibres. It is, however, desirable in principle to widen the field of application of polycarbonates to include tapes because compared to the other customary thermoplastic plastics, such as polyamide or polypropylene, polycarbonates exhibit reduced volume shrinkage during solidification. Polycarbonates further exhibit a higher glass transition temperature Tg, a greater heat resistance and a lower water absorption compared to other thermoplastics.

In order to allow use of polycarbonate in the production of tapes it is thus necessary in particular to perform the joining of the adjacent segments in the region of their longitudinal edges in ideally flawless fashion.

Tapes comprising polycarbonate as the matrix material moreover make it possible to provide a multilayer composite having an aesthetically pleasing low-waviness surface coupled with good mechanical properties. Such a multilayer composite constructed from tapes comprising polycarbonate as the matrix material exhibits metal-like haptics, optics and acoustics.

These properties also make such a multilayer composite suitable as a housing material for housings for electronic devices, in particular portable electronic devices such as laptops or smartphones, and for exterior and interior trim of automobiles since such a multilayer composite can bear mechanical load as well as offering an exceptional outer appearance.

It is accordingly an object of the present invention to overcome the disadvantages of the prior art.

It is a particular object of the present invention to provide an apparatus with which an x°-tape constructed from sheeting sections can be produced where the fibres are embedded in a matrix of polycarbonate and have an angle x having a magnitude from non-0° to 90° inclusive to the running direction of the x°-tape, wherein—viewed from above, in plan view for short—the main components of the apparatus are arranged such that they have no bend in their arrangement.

It is a further particular object of the present invention to provide an apparatus with which an x°-tape constructed from sheeting sections can be produced where the fibres are embedded in a matrix of polycarbonate and have an angle non-0° to the running direction of the x°-tape, wherein the main components of the apparatus are arranged such that in plan view the main axis of the apparatus forms a straight line so that the advancement direction of the 0°-tape, of the sheeting sections cut therefrom and of the x°-tape during the production thereof remains unchanged and coincides with the running direction of the 0°-tape and the x°-tape. In other words the main axis of the apparatus forms a straight line on its footprint.

It is a further particular object of the present invention to provide an apparatus with which compared to the prior art a less fault-susceptible joining of adjacent sheeting sections of tapes in the region of their longitudinal edges is possible and which thus makes it possible to produce an x°-tape constructed from sheeting sections where the fibres are embedded in a matrix of polycarbonate and have an angle non-0° to the running direction of the x°-tape.

The object is achieved by an apparatus comprising the following main components:

(A) a cutting device;
(B) a handling device;
(C) a joining device,
which follow one another in the above order in the apparatus.

The following additional components are arranged upstream of the cutting device (A):

(D) an unwinding device;
(E) a first storage unit (accumulator);
(F) a feeding device.

The following additional components are arranged downstream of the joining device (C):

(G) a take-off device;
(H) a second storage unit (accumulator);
(J) a winding-up device.

This results in the following sequence of main and additional components in the advancement direction:
D-E-F-A-B-C-G-H-J.

The unwinding device (D) may for example comprise a roll on which the 0°-tape is wound up. However, other implementations of the unwinding device (D) are also possible. The 0°-tape generally has a length of 100 to 3000 m, a width of 60 to 2100 mm, preferably of 500 to 1000 mm, particularly preferably of 600 to 800 mm, and a thickness of 100 to 350 μm, preferably of 120 to 200 μm in the running direction. However, a 0°-tape having other dimensions may also be processed on the apparatus according to the invention.

As already indicated, such 0°-tapes having a thermoplastic matrix and the production thereof are known per se, for example from EP 2 631 049 A1. However, unidirectionally endless-fibre-reinforced semifinished sheetings where the fibres are aligned at an angle of 0° to this semifinished sheeting in the running direction and long edges of the semifinished sheeting run parallel to one another and which have other dimensions may likewise be employed.

0°-tapes where the matrix material consists to an extent of at least 50 wt %, preferably at least 60%, preferably at least 70 wt %, particularly preferably to an extent of at least 90 wt %, very particularly preferably at least 95 wt %, in particular to an extent of at least 97 wt %, of a polycarbonate-based thermoplastic are preferred. Expressed another way, in the context of the present invention a polycarbonate-based thermoplastic may comprise not more than 50 wt %, preferably not more than 40 wt %, preferably not more than 30 wt %, in particular not more than 20 wt %, particularly preferably not more than 10 wt %, very particularly preferably not more than 5 wt %, in particular not more than 3 wt %, of one or more constituents distinct from polycarbonate as blend partners.

It is preferable when the polycarbonate-based thermoplastic consists substantially, in particular to an extent of 100 wt %, of poly carbonate.

When reference is made here to polycarbonate this also comprehends mixtures of different polycarbonates. Polycarbonate is furthermore used here as an umbrella term and thus comprises both homopolycarbonates and copolycarbonates. The polycarbonates may further be linear or branched in known fashion.

It is preferable when the polycarbonate-based plastic consists to an extent of 70 wt %, 80 wt %, 90 wt % or substantially, in particular to an extent of 100 wt %, of a linear polycarbonate.

The polycarbonates may be produced in known fashion from diphenols, carbonic acid derivatives and optionally chain terminators and branching agents. Particulars pertaining to the production of polycarbonates have been well known to one skilled in the art for at least about 40 years. Reference may be made here for example to Schnell, Chemistry and Physics of Polycarbonates, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in BeckerBraun, Kunststoff-Handbuch, Volume 31, Polycarbonate, Polyacetale, Polyester, Celluloseester, Carl Hanser Verlag Munich, Vienna 1992, pages 117-299.

Aromatic polycarbonates are produced for example by reaction of diphenols with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of diphenols with for example diphenyl carbonate is likewise possible. Diphenols suitable for producing polycarbonates are for example hydroquinone, resorcinol, dihydroxybiphenyls, bis(hydroxyphenyl)alkanes, bis(hydroxyphenyl)cycloalkanes, bis(hydroxyphenyl)sulphides, bis(hydroxyphenyl)ethers, bis(hydroxyphenyl)ketones, bis(hydroxyphenyl)sulphones, bis(hydroxyphenyl)sulphoxides, α,α′-bis(hydroxyphenyl)diisopropylbenzenes, phthalimidines derived from isatin derivatives or from phenolphthalein derivatives, and also the related ring-alkylated, ring-arylated and ring-halogenated compounds.

Preferably employed diphenols are those based on phthalimides, for example 2-aralkyl-3,3′-bis(4-hydroxyphenyl)phthalimides or 2-aryl-3,3′-bis(4-hydroxyphenyl)phthalimides such as 2-phenyl-3,3′-bis(4-hydroxyphenyl)phthalimide, 2-alkyl-3,3′-bis(4-hydroxyphenyl)phthalimides, such as 2-butyl-3,3′-bis(4-hydroxyphenyl)phthalimides, 2-propyl-3,3′-bis(4-hydroxyphenyl)phthalimides, 2-ethyl-3,3′-bis(4-hydroxyphenyl)phthalimides or 2-methyl-3,3′-bis(4-hydroxyphenyl)phthalimides and also diphenols based on isatins substituted at the nitrogen such as 3,3-bis(4-hydroxyphenyl)-1-phenyl-1H-indol-2-one or 2,2-bis(4-hydroxyphenyl)-1-phenyl-1H-indol-3-one.

Preferred diphenols are 4,4′-dihydroxybiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulphone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and other suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph H. Schnell, Chemistry and Physics of Polycarbonates, Interscience Publishers, New York 1964 and also in JP-A 620391986, JP-A 620401986 and JP-A 1055501986.

In the case of homopolycarbonates only one diphenol is employed and in the case of copolycarbonates two or more diphenols are employed.

Examples of suitable carboxylic acid derivatives include phosgene or diphenyl carbonate. Suitable chain terminators that may be employed in the production of polycarbonates are monophenols. Suitable monophenols are for example phenol itself, alkylphenols such as cresols, p-tert-butylphenol, cumylphenol and mixtures thereof.

Preferred chain terminators are phenols which are mono- or polysubstituted with linear or branched, preferably unsubstituted C1 to C30 alkyl radicals or with tert-butyl. Particularly preferred chain terminators are phenol, cumylphenol and/or p-tert-butylphenol. The quantity of chain terminator to be used is preferably from 0.1 to 5 mol %, based on moles of diphenols respectively used. The addition of the chain terminators may be effected before, during or after the reaction with a carboxylic acid derivative.

Suitable branching agents are the trifunctional or more than trifunctional compounds familiar in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4-dihydroxytriphenyl)methyl)benzene and 3,3-bis(3-methyl-4-hydroxyphenyl)-2-oxo-2,3-dihydroindole.

The amount of the branching agents for optional employment is preferably from 0.05 mol % to 3.00 mol % based on moles of diphenols used in each case. The branching agents can either be initially charged with the diphenols and the chain terminators in the aqueous alkaline phase or added dissolved in an organic solvent before the phosgenation. In the case of the transesterification process the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

Furthermore, copolycarbonates may also be used. To produce these copolycarbonates 1 wt % to 25 wt %, preferably 2.5 wt % to 25 wt %, particularly preferably 2.5 wt % to 10 wt %, based on the total amount of diphenols to be employed, of polydiorganosiloxanes having hydroxyaryloxy end groups may be employed. These are known (U.S. Pat. Nos. 3,419,634, 3,189,662, EP 0 122 535, U.S. Pat. No. 5,227,449) and may be produced by methods known in the literature. Likewise suitable are polydiorganosiloxane-containing copolycarbonates; the production of polydiorganosiloxane-containing copolycarbonates is described in DE-A 3 334 782 for example.

The polycarbonates may be present alone or as a mixture of polycarbonates. It is also possible to employ the polycarbonate or the mixture of polycarbonates together with one or more plastics distinct from polycarbonate as blend partners.

Blend partners that may be employed include polyamides, polyesters, in particular polybutylene terephthalate and polyethylene terephthalate, polylactide, polyether, thermoplastic polyurethane, polyacetal, fluoropolymer, in particular polyvinylidene fluoride, polyethersulphones, polyolefin, in particular polyethylene and polypropylene, polyimide, polyacrylate, in particular poly(methyl)methacrylate, polyphenylene oxide, polyphenylene sulphide, polyetherketone, polyaryletherketone, styrene polymers, in particular polystyrene, styrene copolymers, in particular styrene acrylonitrile copolymer, acrylonitrile butadiene styrene block copolymers and polyvinyl chloride.

Up to 50.0 wt %, preferably 0.2 to 40 wt %, particularly preferably 0.10 to 30.0 wt %, based on the weight of the thermoplastic, of other customary additives may optionally also be present.

This group comprises flame retardants, anti-drip agents, thermal stabilizers, demoulding agents, antioxidants, UV absorbers, IR absorbers, antistats, optical brighteners, light-scattering agents, colourants such as pigments, including inorganic pigments, carbon black and/or dyes, and inorganic fillers in amounts customary for polycarbonate. These additives may be added individually or else in a mixture.

Such additives as are typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich.

It may generally be useful to add thermal stabilizers and flow improvers to the polycarbonate used for the matrix provided that these do not reduce the molecular weight of the polycarbonate and/or reduce the Vicat temperature.

Contemplated materials for the fibres include both natural fibres, for example fibrous minerals or vegetable fibres, and man-made fibres, for example inorganic synthetic fibres or organic synthetic fibres. Glass, carbon or polymer fibres are preferred, glass or carbon fibres being preferred in turn.

It is very particularly preferable to employ glass fibres having a modulus of elasticity of greater than 70 GPa, preferably greater than 80 GPa, particularly preferably greater than 90 GPa, or carbon fibres having a modulus of elasticity of greater than 240 GPa, preferably greater than 245 GPa, particularly preferably of 250 GPa or more. Carbon fibres having these aforementioned moduli of elasticity are preferred in particular. Such carbon fibres are for example commercially available from Mitsubishi Rayon CO., LtD. under the trade name Pyrofil.

The fibres are generally coated with a so-called size. If poly carbonate is used as the matrix, suitable systems for sizes often comprise a thermoset, a silane, an epoxy resin or a polyurethane. However it is also possible for the fibres, or a portion of the fibres, to comprise no size.

From this unwinding device (D) the 0°-tape is continuously unwound and fed in the advancement direction to the storage device. The first storage unit (E) then feeds the 0°-tape via the feeding device (F) to the cutting device (A). The first storage unit (E) may for example comprise a plurality of rolls mounted such that they are translationally movable in the direction of gravity or may be configured in another useful fashion. The feeding device (F) may for example be implemented in the form of an unrolling device, conveyor belt or a conveyor roller sector. The feeding device (F) feeds the 0°-tape such that the running direction of the 0°-tape and the advancement direction of the apparatus according to the invention coincide.

The cutting of the 0°-tape is a discontinuous operation. The continuous advancement of the 0°-tape is therefore interrupted at certain intervals in order to be able to perform the cutting operation such that the cut corresponds to a straight line having the angle x to the running direction of the 0°-tape. The cutting device (A) may for example be in the form of a rotary cutter, an impact shear, a plate shear, a guillotine, a lever shear, a laser, a waterjet cutting device, a milling machine, a chopsaw, a band saw, a cutting disc or another suitable embodiment. The cutting device (A) is used to cut sheeting sections from the 0°-tape at a predetermined angle x to the advancement direction of the 0°-tape, wherein the advancement direction is assigned the angle 0°. The magnitude of the angle x is from greater than 0° to 90° inclusive, wherein the angle x preferably has a magnitude of 30°, 33°, 45°, 60°, 75° or 90°; the angle x particularly preferably has a magnitude of 90°. When the angle x is determined clockwise to the advancement direction then the value of the angle x is prefixed with a minus and when the angle x is determined anticlockwise then the value of the angle x is prefixed with a plus which, however, is not shown in line with general convention. The magnitude of the angle x is determined such that it is defined by a smallest possible magnitude. Thus an angle x having a value of 135° would be equal to an angle x having a value of −45°; the magnitude of the angle x of 45° is then reported; an angle x having a value of 120° would be equal to an angle x having a value of −60°; the magnitude of the angle x of 60° is then reported.

The cutting device is preferably configured such that it can be used to set any desired angles between 0° and 90° both clockwise and anticlockwise.

The change from continuous to discontinuous advancement is performed by the feeding device (F), wherein the first storage unit (E) during interruption of the advancement of the 0°-tape intermediately stores the 0°-tape continuously supplied from the unwinding device (D).

In a further discontinuous step the handling device (B) rotates the sheeting sections cut from the 0°-tape in the same plane by the magnitude of the angle x and lays them one behind the other in the advancement direction such that in the sheeting sections the sides which in the 0°-tape were regions of the mutually parallel outsides are now disposed opposite one another. The regions which in the 0°-tape were disposed within said tape now form the mutually parallel outsides. The fibres in the sheeting sections therefore also have an alignment having the angle x to the advancement direction.

It must be ensured that the handling device (B) rotates the sheeting sections by the magnitude of the angle x in the advancement direction in such a way that after the rotation by the angle x the regions which in the 0°-tape were disposed within said tape are now disposed parallel to the advancement direction while the sides which in the 0°-tape were regions of the mutually parallel outsides are now aligned at the magnitude of the angle x to the advancement direction.

The handling device (B) may be configured for example as a robot gripping arm or gripping hand, a turntable, a rotatable suction device, linear guides with a rotation axis or in another suitable fashion.

The handling device (B) is followed in the advancement direction by the joining device (C). In said joining device (C) in a further discontinuous step the sheeting sections are cohesively joined to one another to form the x°-tape such that the sides that in the 0°-tape were regions of the mutually parallel outsides are now disposed within the x°-tape and the mutually parallel outsides of the x°-tape are formed by regions which in the 0°-tape were disposed within said tape. In the x°-tape the fibres accordingly also have an alignment having the magnitude of the angle x to the advancement direction.

The joining device (C) may be configured as a welding device or an adhesive-bonding device. Said device is preferably configured as a welding device, wherein the welding operation is performed for example by means of hot bars, laser, hot air, infrared radiation or ultrasound. In accordance with the invention this join is implemented as an end-to-end join so that there is no overlap of the sheeting sections, i.e. the sheeting sections are joined to one another only at the faces which in the 0°-tape were regions of the mutually parallel outsides, regions of the top or bottom side of the 0°-tape are not involved in the production of the join.

The handling device (B) and/or the joining device (C) may be fitted with a positioning device for the sheeting sections. The positioning device makes possible in particular a joining of adjacent sheeting sections of tapes in the region of their longitudinal edges which is less susceptible to faults compared to the prior art and thus makes it possible in particularly advantageous fashion to produce an x°-tape constructed from sheeting sections where the fibres are embedded in a matrix of polycarbonate and have an angle non-0° to the running direction of the x°-tape.

The joining device is followed in the advancement direction by a take-off device (G) which effects further transportation of the x°-tape. On account of the discontinuous operation of the joining device (C) and the discontinuous growth in length of the x°-tape arising therefrom this further transportation is initially likewise discontinuous. The take-off device (G) is then followed by a second storage unit (H) which converts the discontinuous advancement into a continuous advancement. This second storage unit (H) may be configured in an identical or different manner than the first storage unit (E) which is located upstream of the cutting device. The storage is followed by a winding-up device (J) which winds the x°-tape onto a core.

The apparatus according to the invention makes it possible to arrange its main components such that they form a straight line in the plane of its footprint so that the advancement directions of the 0°-tape, of the sheeting sections cut therefrom and of the x°-tape during production thereof are identical and remain unchanged and the main axis of the apparatus forms a straight line.

In particular the handling device (B) of the apparatus according to the invention makes it possible for the cutting device (A), the handling device (B) and the joining device (C) to form a straight line in the plane of its footprint so that the advancement directions of the 0°-tape, of the sheeting sections cut therefrom and of the 0°-tape during production thereof are identical and remain unchanged. This arrangement has the result that compared to arrangements from the prior art less room is required and a plurality of apparatuses according to the invention may be more easily accommodated in a machine hall.

In addition in the case of the apparatus according to the invention it is no longer necessary to alter the angle between the cutting device (A) and the joining device in order to set different angles x but rather it is sufficient for the handling device (B) to rotate the segments correspondingly to the altered angle x. This saves labour and brings additional space advantages.

It is particularly advantageous when not only the main components A to C but also the feeding device (F) and the take-off device (G) together with the main components A to C are arranged such that in plan view the main axis of the apparatus forms a straight line so that the advancement directions of the 0°-tape, of the sheeting sections cut therefrom and of the x°-tape during production thereof are identical and remain unchanged. This configuration of the apparatus according to the invention is particularly space-saving and the advantage that it is no longer necessary to alter the angle between the cutting device (A) and the joining device (C) in order to set different angles x is particularly strongly brought to bear therein.

It is very particularly advantageous when all components D-E-F-A-B-C-G-H-J are arranged such that in plan view the main axis of the apparatus forms a straight line.

The use of the handling device makes it possible to arrange the main components of the apparatus according to the invention such that in plan view the main axis of the apparatus forms a straight line so that the advancement directions of the 0°-tape, of the sheeting sections cut therefrom and of the x°-tape during production thereof are identical and remain unchanged.

The apparatus according to the invention also makes possible a joining of adjacent sheeting sections in the region of their longitudinal edges which is less susceptible to faults compared to the prior art and thus makes it possible to produce an x°-tape constructed from sheeting sections where the fibres are embedded in a matrix of polycarbonate and have an angle non-0° to the running direction of the x°-tape.

These x°-tapes make it possible to produce a multilayer composite that exhibits an aesthetically pleasing low-waviness surface coupled with good mechanical properties. Such a multilayer composite constructed from tapes comprising polycarbonate as the matrix material exhibits metal-like haptics, optics and acoustics and is thus also suitable as a housing material for housings for electronic devices, in particular portable electronic devices such as laptops or smartphones and for exterior and interior trim of automobiles since such a multilayer composite can bear mechanical load as well as offering an exceptional outer appearance.

The present invention also provides a process for producing a semifinished sheeting in which the fibres are aligned at an angle x having a magnitude from non-0° to 90° inclusive to the running direction of the final semifinished sheeting. The process according to the invention is preferably performed on the above described apparatus according to the invention.

Said process comprises the steps of:

(1) cutting the 0°-tape into sheeting sections;
(2) rotating the sheeting sections by the magnitude of the angle x;
(3) cohesively joining the sheeting sections to afford the x°-tape,
wherein the advancement direction of the 0°-tape, of the sheeting sections cut therefrom and of the x°-tape during production thereof is kept unchanged.

As previously indicated it must be ensured that the handling device (B) rotates the sheeting sections by the magnitude of the angle x in the advancement direction in such a way that after the rotation by the angle x the regions which in the 0°-tape were disposed within said tape are now disposed parallel to the advancement direction while the sides which in the 0°-tape were regions of the mutually parallel outsides are now aligned at the magnitude of the angle x to the advancement direction.

The process makes it possible to arrange the main components of the apparatus according to the invention such that in plan view the main axis of the apparatus forms a straight line so that the advancement directions of the 0°-tape, of the sheeting sections cut therefrom and of the x°-tape during production thereof are identical and remain unchanged.

Process step (2) in particular makes it possible to arrange the main components of the apparatus according to the invention such that in plan view their main axis forms a straight line so that the advancement directions of the 0°-tape, of the sheeting sections cut therefrom and of the x°-tape during production thereof are identical and remain unchanged and the main axis of the apparatus forms a straight line.

This has the result that compared to arrangements from the prior art an apparatus which performs the process according to the invention requires less room and a plurality of apparatuses according to the invention may therefore be more easily accommodated in a machine hall.

It is particularly advantageous when the additional process steps of

(0) feeding the 0°-tape and
(4) winding-up the x°-tape
are also performed such that the advancement direction of the 0°-tape, of the sheeting sections cut therefrom and of the x°-tape during production thereof is kept unchanged. Process step (0) is performed before process step (1) and process step (4) is performed after process step (3).

This configuration of the process according to the invention allows for a particularly space-saving arrangement of the apparatus according to the invention and the advantage that it is no longer necessary to alter the angle between the cutting device (A) and the joining device in order to set different angles x is particularly strongly brought to bear therein.

The performance of the process according to the invention also makes possible a joining of adjacent sheeting sections in the region of their longitudinal edges which is less susceptible to faults compared to the prior art and thus makes it possible to produce an x°-tape constructed from sheeting sections where the fibres are embedded in a matrix of polycarbonate and have an angle non-0° to the running direction of the x°-tape.

These x°-tapes make it possible to produce a multilayer composite that exhibits an aesthetically pleasing low-waviness surface coupled with good mechanical properties. Such a multilayer composite constructed from tapes comprising polycarbonate as the matrix material exhibits metal-like haptics, optics and acoustics and is thus also suitable as a housing material for housings for electronic devices, in particular portable electronic devices such as laptops or smartphones and for exterior and interior trim of automobiles since such a multilayer composite can bear mechanical load as well as offering an exceptional outer appearance.

It is preferable when the process according to the invention is performed using the apparatus according to the invention.

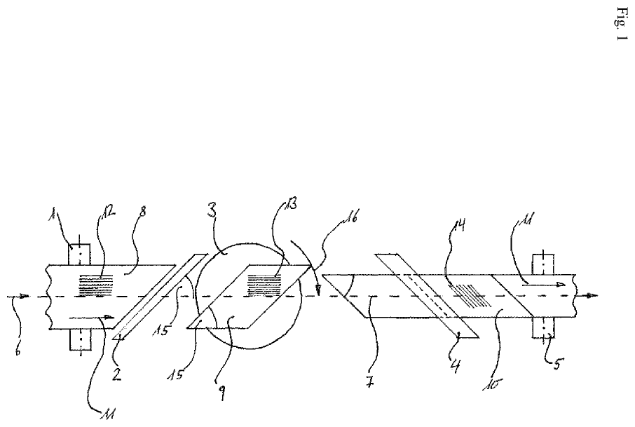

FIG. 1 shows a simplified form of the apparatus according to the invention without any intention to limit the invention.

The reference numerals have the following meanings:
1 feeding device (F)
2 cutting device (A)
3 handling device (B)
4 joining device (C)
5 take-off device (G)
6 advancement direction
7 main axis of apparatus according to the invention
8 0°-tape
9 sheeting section
10 x°-tape
11 running direction of 0°-tape/x°-tape
12 alignment of fibres in 0°-tape
13 alignment of fibres in sheeting section
14 alignment of fibres in x°-tape
15 angle x
16 direction in which the sheeting section is rotated by the handling device

1. An apparatus for semicontinuous production of an x°-tape which is a semifinished sheeting constructed from unidirectionally endless-fibre-reinforced sheeting sections, wherein the fibres in this semifinished sheeting are embedded in a matrix of polycarbonate and aligned at an angle x having a magnitude from non-0° to 90° inclusive to the running direction of the x°-tape, comprising the following main components:
(A) a cutting device;
(B) a handling device; and
(C) a joining device,
which follow one another in the above order in the apparatus, wherein the main components are arranged such that in plan view the main axis of the apparatus forms a straight line.

2. The apparatus according to claim 1, wherein the cutting device (A) has a feeding device (F), a first storage unit (E) and an unwinding device (D) arranged upstream of it and the joining device (C) has a take-off device (G), a second storage unit (H) and a winding-up device (J) arranged downstream of it such that the sequence D-E-F-A-B-C-G-H-J results.

3. The apparatus according to claim 2, wherein the main components (A) to (C), the feeding device (F) and the take-off device (G) are arranged such that the main axis of the apparatus forms a straight line in the plane of a footprint of the apparatus.

4. The apparatus according to claim 1, wherein the handling device (B) is suitable for laying the sheeting sections cut from a 0°-tape rotated in the same plane by the magnitude of the angle x one behind the other in the advancement direction of the 0°-tape such that in the sheeting sections the sides which in the 0°-tape were regions of the mutually parallel outsides are now disposed opposite one another.

5. The apparatus according to claim 4, wherein the handling device (B) is configured as at least one of a robot gripping arm or gripping hand, a turntable and a rotatable suction device.

6. The apparatus according to claim 1, wherein the angle x has a magnitude from greater than 0° to 90° inclusive.

7. The apparatus according to claim 1, wherein at least one of the handling device (B) and the joining device (C) is/are fitted with a positioning device for the sheeting sections.

8. A process for producing an x°-tape which is a semifinished sheeting constructed from unidirectionally endless-fibre-reinforced sheeting sections, wherein the fibres are embedded in a matrix of polycarbonate and in this semifinished sheeting are aligned at an angle x having a magnitude from non-0° to 90° inclusive to the running direction of the final semifinished sheeting, comprising the following process steps:
(1) cutting the 0°-tape into sheeting sections;
(2) rotating the sheeting sections by the magnitude of the angle x; and
(3) cohesively joining the sheeting sections to afford the x°-tape,
wherein the advancement direction of the 0°-tape, of the sheeting sections cut therefrom and of the x°-tape during production thereof is kept unchanged.

9. The process according to claim 8, wherein before process step (1) process step
(0) feeding the 0°-tape
is performed and after process step (3) process step
(4) winding-up the x°-tape
is performed.

10. The process according to claim 9, wherein during process steps (0) to (4) the advancement direction of the 0°-tape, of the sheeting sections cut therefrom and of the x°-tape during production thereof is kept unchanged.

11. The process according to claim 8, wherein the process is performed on an apparatus according to claim 1.

12. The process according to claim 8 further comprising utilizing the apparatus according to claim 1.
